(19) United States
(12) Patent Application Publication
(10) Pub. No.: US 2021/0039391 A1
(43) Pub. Date: Feb. 11, 2021

(54) FLUID EJECTION UNIT WITH CIRCULATION LOOP AND FLUID BYPASS

(71) Applicant: Hewlett-Packard Development Company, L.P., Spring, TX (US)

(72) Inventors: Lawrence H. White, Corvallis, OR (US); Angel L. Morales, Corvallis, OR (US); Erik D. Torniainen, Corvallis, OR (US)

(73) Assignee: Hewlett-Packard Development Company, L.P., Spring, TX (US)

(21) Appl. No.: 16/978,859

(22) PCT Filed: Apr. 26, 2018
(86) PCT No.: PCT/US2018/029619

§ 371 Date: Sep. 8, 2020

(51) Int. Cl. B41J 2/14

(52) U.S. Cl. CPC B41J 2/14145; B41J 2002/14467

(57) ABSTRACT

A fluid ejection unit may include a fluid supply passage, a fluid circulation loop having a first segment extending from the fluid supply passage, a second segment extending from the fluid supply passage and a bend connecting the first segment and the second segment, a fluid ejector along the second segment, the fluid ejector comprising a fluid ejection orifice and a fluid actuator and a fluid bypass spaced from the fluid actuator and in parallel with the bend to connect the first segment and the second segment.

### BACKGROUND

Some unit selectively eject fluid through an ejection opening or orifice. Examples of such unit include print heads and diagnostic dies, such as lab on chip applications.

### BRIEF DESCRIPTION OF THE DRAWINGS

FIG. 1 is a schematic diagram of portions of an example fluid ejection unit.

FIG. 2 is a sectional view of portions of an example fluid ejection unit taken along line 2,3 of FIG. 1.

FIG. 3 is a sectional view of portions of an example fluid ejection unit taken along line 2,3 of FIG. 1.

FIG. 4 is a flow diagram of an example fluid circulation method.

FIG. 5 is a flow diagram of an example fluid circulation method.

FIG. 6 is a schematic diagram of portions of an example fluid ejection unit.

FIG. 7 is a schematic diagram of portions of an example fluid ejection unit.

FIG. 8 is a schematic diagram of portions of an example fluid ejection unit.

FIG. 9 is a schematic diagram of portions of an example fluid ejection unit.

FIG. 10 is a schematic diagram of portions of an example fluid ejection unit.

FIG. 11 is a schematic diagram of an example fluid ejection system that may utilize any of the disclosed example fluid ejection unit.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed herein are example fluid ejection unit and methods that may facilitate enhanced fluid ejection reliability and control. The example fluid ejection unit and methods direct a flow of fluid along a fluid circulation passage along which a fluid ejector is located. The example fluid ejection unit and methods further direct a bypass flow of fluid from the circulation passage through a fluid bypass and across the fluid ejector. The fluid bypass facilitates the removal of bubble and particle constrictions from the circulation passage. The fluid bypass may further facilitate the flow of fluid around or passed any such constrictions. As a result, fluid ejection reliability is enhanced.

In one implementation, the fluid bypass is spaced from a fluid actuator of the fluid ejector. In some implementations, the fluid bypass has an upstream or downstream from the fluid actuator of the fluid ejector. As a result, fluid being displaced by the fluid actuator of the fluid ejector is less likely to directly flow through the fluid bypass absent a constriction, shortcutting a bend of the circulation passage.

In one implementation, the circulation passage further comprises second fluid actuator in a separate portion of the circulation passage to pump fluid along the circulation passage and across the fluid ejector. For example, in one implementation, the second fluid actuator may comprise an inertial pump. In such an implementation, the fluid bypass is further spaced from the second fluid actuator such that actuation of the second fluid actuator is less likely to interfere with the ejection of fluid by the fluid ejector.

In one implementation, the fluid circulation passage comprises a fluid circulation loop having a pair of segments interconnected by a bend. In one implementation, the bend may be curved. In another implementation, the bend may have corners. In one implementation, the fluid bypass extends between the pair of segments in parallel with the bend. In one implementation, the fluid bypass extends towards an apex of the bend in parallel with or oblique to at least one of the segments.

In some implementations, the fluid ejection unit may comprise multiple fluid bypasses. For example, in one implementation, the fluid ejection unit may comprise multiple fluid bypasses that extend between the first and second segments in parallel with the bend. In one implementation, the fluid ejection unit may comprise a first fluid bypass that extends between the first and second segments in parallel with the bend and a second fluid bypass that extends to an apex of the band, parallel to or along the first and second segments. In some implementations, the second fluid bypass may intersect the first fluid bypass.

In some implementations, the fluid circulation passage or fluid circulation loop is coplanar with the fluid bypass. In other implementations, at least one of the fluid bypasses may extend above or below the fluid circulation passage or fluid circulation loop, not coplanar with the fluid circulation passage or loop.

In some implementations, the fluid circulation passage or loop has an inlet and an outlet connected to a fluid supply passage, wherein the loop circulates fluid from the fluid supply passage and back to the fluid supply passage. In other implementations, the fluid circulation passage may receive a fluid from a fluid supply through and inlet and may discharge fluid through an outlet to a fluid discharge volume which is distinct from the fluid supply. In some implementations, the fluid discharge volume may ultimately be fluidly connected to the fluid supply.

As will be appreciated, examples provided herein may be formed by performing various microfabrication and/or micromachining processes on a substrate to form and/or connect structures and/or components. Substrates forming the various fluidic components may comprise a silicon based wafer or other such similar materials used for microfabricated devices (e.g., glass, gallium arsenide, plastics, etc.). Examples may comprise microfluidic channels, fluid actuators, and/or volumetric chambers. Microfluidic channels and/or chambers may be formed by performing etching, microfabrication processes (e.g., photolithography), or micromachining processes in a substrate. Accordingly, microfluidic channels and/or chambers may be defined by surfaces fabricated in the substrate of a microfluidic device. In some implementations, microfluidic channels and/or chambers may be formed by an overall package, wherein multiple connected package components combine to form or define the microfluidic channel and/or chamber.

In some examples described herein, at least one dimension of a microfluidic channel and/or capillary chamber may be of sufficiently small size (e.g., of nanometer sized scale, micrometer sized scale, millimeter sized scale, etc.) to facilitate pumping of small volumes of fluid (e.g., picoliter scale, nanoliter scale, microliter scale, milliliter scale, etc.). For example, some microfluidic channels may facilitate capillary pumping due to capillary force. In addition, examples may couple at least two microfluidic channels to a microfluidic output channel via a fluid junction.

The fluid passages, such as microfluidic passages, may facilitate conveyance of different fluids (e.g., liquids having different chemical compounds, different physical properties, different concentrations, etc.) to the microfluidic output channel. In some examples, fluids may have at least one different fluid characteristic, such as vapor pressure, temperature, viscosity, density, contact angle on channel walls, surface tension, and/or heat of vaporization. It will be appreciated that examples disclosed herein may facilitate manipulation of small volumes of liquids.

The fluid actuator used to displace fluid through the ejection orifice as part of the fluid ejector may comprise a thermal resistive fluid actuator, a piezo-membrane based actuator, and electrostatic membrane actuator, mechanical/impact driven membrane actuator, a magnetostrictive drive actuator, and electrochemical actuator, and external laser actuators (that form a bubble through boiling with a laser beam), other such microdevices, or any combination thereof. In some implementations, the fluid actuators may displace fluid through movement of a membrane (such as a piezo-electric membrane) that generates compressive and tensile fluid displacements to thereby cause inertial fluid flow.

As used herein, an inertial pump corresponds to a fluid actuator and related components disposed in an asymmetric position in a fluid channel, where an asymmetric position of the fluid actuator corresponds to the fluid actuator being positioned less distance from a first end of the fluid channel as compared to a distance to a second end of the fluid channel. Accordingly, in some examples, a fluid actuator of an inertial pump is not positioned at a mid-point of a fluid channel. The asymmetric positioning of the fluid actuator in the fluid channel facilitates an asymmetric response in fluid proximate the fluid actuator that results in fluid displacement when the fluid actuator is actuated. Repeated actuation of the fluid actuator causes a pulse-like flow of fluid through the fluid channel.

In some examples, an inertial pump includes a thermal actuator having a heating element (e.g., a thermal resistor) that may be heated to cause a bubble to form in a fluid proximate the heating element. In such examples, a surface of a heating element (having a surface area) may be proximate to a surface of a fluid channel in which the heating element is disposed such that fluid in the fluid channel may thermally interact with the heating element. In some examples, the heating element may comprise a thermal resistor with at least one passivation layer disposed on a heating surface such that fluid to be heated may contact a topmost surface of the at least one passivation layer. Formation and subsequent collapse of such bubble may generate flow of the fluid. As will be appreciated, asymmetries of the expansion-collapse cycle for a bubble may generate such flow for fluid pumping, where such pumping may be referred to as “inertial pumping.”

In other examples, the fluid actuator(s) forming an inertial pump or used to eject fluid through an ejection orifices or nozzle may comprise piezo-membrane based actuators, electrostatic membrane actuators, mechanical/impact driven membrane actuators, magnetostrictive drive actuators, electrochemical actuators, external laser actuators (that form a bubble through boiling with a laser beam), other such microdevices, or any combination thereof. In some implementations, the fluid actuators may displace fluid through movement of a membrane (such as a piezo-electric membrane) that generates compressive and tensile fluid displacements to thereby cause inertial fluid flow.

As will be appreciated, the fluid actuator forming the inertial pump may be connected to a controller, and electrical actuation of the fluid actuator by the controller may thereby control pumping of fluid. Actuation of the fluid actuator may be of relatively short duration. In some examples, the fluid actuator may be pulsed at a particular frequency for a particular duration. In some examples, actuation of the fluid actuator may be 1 microsecond (μs) or less. In some examples, actuation of the fluid actuator may be within a range of approximately 0.1 microsecond (μs) to approximately 10 milliseconds (ms). In some examples described herein, actuation of the fluid actuator includes electrical actuation. In such examples, a controller may be electrically connected to a fluid actuator such that an electrical signal may be transmitted by the controller to the fluid actuator to thereby actuate the fluid actuator. Each fluid actuator of an example microfluidic device may be actuated according to actuation characteristics. Examples of actuation characteristics include, for example, frequency of actuation, duration of actuation, number of pulses per actuation, intensity or amplitude of actuation, phase offset of actuation.

Disclosed herein is a fluid ejection unit that may include a fluid supply passage, a fluid circulation loop having a first segment extending from the fluid supply passage, a second segment extending from the fluid supply passage and a bend connecting the first segment and the second segment, a fluid ejector along the second segment, the fluid ejector comprising a fluid ejection orifice and a fluid actuator and a fluid bypass spaced from the fluid actuator and in parallel with the bend to connect the first segment and the second segment.

Disclosed herein is an example method that comprises directing a flow of fluid from a fluid supply passage through a fluid circulation loop, around the bend of the circulation loop connecting a first segment and a second segment, across a fluid ejector and back to the fluid supply passage. The method further involves directing a bypass flow of fluid from the fluid supply passage across the fluid ejector and back to the fluid supply passage through a fluid bypass spaced from a first fluid actuator in the first segment and a second fluid actuator and the second segment, in parallel with the bend.

Disclosed herein is an example method that comprises directing a flow of fluid from a fluid supply passage through a fluid circulation loop, around the bend of the circulation loop, across the fluid ejector and back to the fluid supply passage. The method further comprises directing a bypass flow of fluid from the fluid supply passage across the fluid ejector and back to the fluid supply passage to a fluid bypass coplanar with the circulation loop.

Disclosed herein is an example fluid ejection unit that comprises a fluid circulation passage having an inlet and an outlet, a fluid actuator along the fluid circulation passage, a fluid ejector along the fluid circulation passage and a fluid bypass coplanar with the fluid circulation passage and extending from a first portion of the fluid circulation passage to a second portion of the fluid circulation passage. In one implementation, the inlet and the outlet are connected to the same fluid supply passage. In other implementations, the inlet and the outlet are connected to distinct supply in discharge passages or volumes.

Examples described herein may be referred to as fluid ejection unites. Examples of fluid ejection unites may include fluid ejection dies, such as printheads, lab-on-a-chip devices, agent distributors used in additive manufacturing systems, and/or other such similar devices that may selectively eject fluid drops.

FIG. 1 is a schematic diagram illustrating portions of an example fluid ejection unit 20. Unit 20 directs a bypass flow of fluid from a circulation passage through a fluid bypass and across a fluid ejector. The fluid bypass facilitates the removal of bubble and particle constrictions from the circulation passage. The fluid bypass may further facilitate the flow of fluid around or passed any such constrictions. As a result, fluid ejection reliability is enhanced. Unit 20 comprises fluid supply passage 24, fluid circulation loop 30, fluid ejector 34 and fluid bypass 40.

Fluid supply passage 24 supplies fluid, such as ink or other fluids, for being ejected by fluid ejector 34. Fluid supply passage 24 is formed in a substrate or body 22. In one implementation, fluid supply passage 24 comprises an elongated slot. In other implementations, fluid supply passage 24 may comprise other fluid passages. In one implementation, fluid supply passage 24 comprises a microfluidic passage which receives fluid from a reservoir of a fluid supply cartridge or from an off-axis fluid supply.

Fluid circulation loop 30 comprises a fluid passage having a first segment 42 extending from fluid supply passage 24, a second segment 44 extending from fluid supply passage 24 and a bend 46 connecting segment 42 and segment 44. Although bend 46 is illustrated as being curved or arcuate, in other implementations, bend 46 may be polygonal, including various corners. In one implementation, fluid circulation loop 30 comprises a microfluidic passage which circulates fluid from fluid supply passage 24, around bend 46 and across fluid ejector 34 to reduce settling of particles in the fluid or to provide fluid ejector 34 with fresh fluid for ejection.

Fluid ejector 34 controllably ejects fluid. Fluid ejector 34 is located along segment 42 and comprises an ejection orifice 48 and a fluid actuator 50. Fluid actuator 50 comprises devices or elements that cause displacement of fluid through ejection orifice 48 in response to electrical actuation. In one implementation, fluid ejector 34 comprises an enlarged interior forming a firing or ejection chamber along segment 42. Fluid actuator 50 may comprise a piezoelectric membrane based actuator, a thermal resistor based actuator, an electrostatic membrane actuator, a mechanical/impact driven membrane actuator, a magneto-strictive drive actuator, or other such elements. In one implementation, fluid actuator 50 of fluid ejector 34 specifically comprises a thermal resistor based actuator which heats adjacent fluid to form a bubble that expels fluid through the associated orifice 48.

In one implementation, fluid is directed through circulation passage 30 and across fluid ejector 34 using fluid pressure differentials. In other implementations, additional pumping elements or devices may be utilized to further facilitate circulation of fluid through circulation passage 46 and across fluid ejector 34. As shown by broken lines, in some implementations, unit 20 may additionally comprise a fluid pump in the form of a fluid actuator 54 which forms an inertial pump. As used herein, an inertial pump corresponds to a fluid actuator and related components disposed in an asymmetric position in a fluid channel, where an asymmetric position of the fluid actuator corresponds to the fluid actuator being positioned less distance from a first end of the fluid channel as compared to a distance to a second end of the fluid channel. Accordingly, in some examples, a fluid actuator of an inertial pump is not positioned at a mid-point of a fluid channel. The asymmetric positioning of the fluid actuator in the fluid channel facilitates an asymmetric response in fluid proximate the fluid actuator that results in fluid displacement when the fluid actuator is actuated. Repeated actuation of the fluid actuator causes a pulse-like flow of fluid through the fluid channel. Fluid actuator 54 is located within segment 44 of circulation passage 30.

In some examples, fluid actuator 54 may comprise a heating element (e.g., a thermal resistor) that may be heated to cause a bubble to form in a fluid proximate the heating element. In such examples, a surface of a heating element (having a surface area) may be proximate to a surface of a fluid channel in which the heating element is disposed such that fluid in the fluid channel may thermally interact with the heating element. In some examples, the heating element may comprise a thermal resistor with at least one passivation layer disposed on a heating surface such that fluid to be heated may contact a topmost surface of the at least one passivation layer. Formation and subsequent collapse of such bubble may generate flow of the fluid. As will be appreciated, asymmetries of the expansion-collapse cycle for a bubble may generate such flow for fluid pumping, where such pumping may be referred to as “inertial pumping.”

In other examples, fluid actuator 54 forming an inertial pump may comprise piezo-membrane based actuators, electrostatic membrane actuators, mechanical/impact driven membrane actuators, magnetostrictive drive actuators, electrochemical actuators, external laser actuators (that form a bubble through boiling with a laser beam), other such microdevices, or any combination thereof. In some implementations, the fluid actuators may displace fluid through movement of a membrane (such as a piezo-electric membrane) that generates compressive and tensile fluid displacements to thereby cause inertial fluid flow.

As will be appreciated, the fluid actuator forming the inertial pump may be connected to a controller, and electrical actuation of the fluid actuator by the controller may thereby control pumping of fluid. Actuation of the fluid actuator may be of relatively short duration. In some examples, the fluid actuator may be pulsed at a particular frequency for a particular duration. In some examples, actuation of the fluid actuator may be 1 microsecond (μs) or less. In some examples, actuation of the fluid actuator may be within a range of approximately 0.1 microsecond (μs) to approximately 10 milliseconds (ms). In some examples described herein, actuation of the fluid actuator includes electrical actuation. In such examples, a controller may be electrically connected to a fluid actuator 54 such that an electrical signal may be transmitted by the controller to the fluid actuator to thereby actuate the fluid actuator. Fluid actuator 54 may be actuated according to actuation characteristics. Examples of actuation characteristics include, for example, frequency of actuation, duration of actuation, number of pulses per actuation, intensity or amplitude of actuation, phase offset of actuation.

Fluid bypass 40 interconnects segments 42 and 44, bypassing bend 46. Fluid bypass 40 extends between segments 42 and 44 in parallel (as compared to being in series) with bend 46. In one implementation, fluid bypass 40 has a width of at least 5 μm and a height of at least 11 μm or less or equal to 50 μm to facilitate sufficient fluid flow through the bypass while not detrimentally producing flow through bend 46. In one implementation, bypass 40 has a length that is sufficiently short such that fluid may flow through bypass 40 with a given pressure differentials or the capabilities of the fluid actuator 54 serving as an inertial pump (when provided) and sufficiently long so as to reduce or eliminate cross talk between fluid being displaced by actuators 34 and 54. In one implementation, fluid bypass 40 is formed in a layer of SU eight and has a length of at least 5 μm and no greater than 21 μm (based upon a fluid actuator-to-fluid actuator pitch). In other implementations, such as where fluid bypass 40 is formed from other materials or other processes, or where the fluid ejection device is low-density, fluid bypass 40 may have a greater length.

Fluid bypass 40 is spaced from fluid actuator 50, having an inlet/outlet opening 56 spaced between actuator 50 and bend 46. In implementations where unit 20 comprises fluid actuator 54, fluid bypass 40 is also spaced from fluid actuator 54, having an inlet/outlet opening 58 spaced between actuator 54 and bend 46. In one implementation, opening 56 is spaced from actuator 50 by a distance D1 of at least 5 μm. In one implementation, opening 58 is spaced from actuator 54 by a distance D2 of at least 5 μm. The spacing of fluid bypass 40 from actuator 50 reduces the likelihood of fluid directly flowing through the fluid bypass absent a constriction, shortcutting a bend of the circulation passage. The spacing of bypass 40 from fluid actuator 54 reduces a likelihood of fluid being displaced by fluid actuator 54 interfering with the ejection of fluid by the fluid ejector.

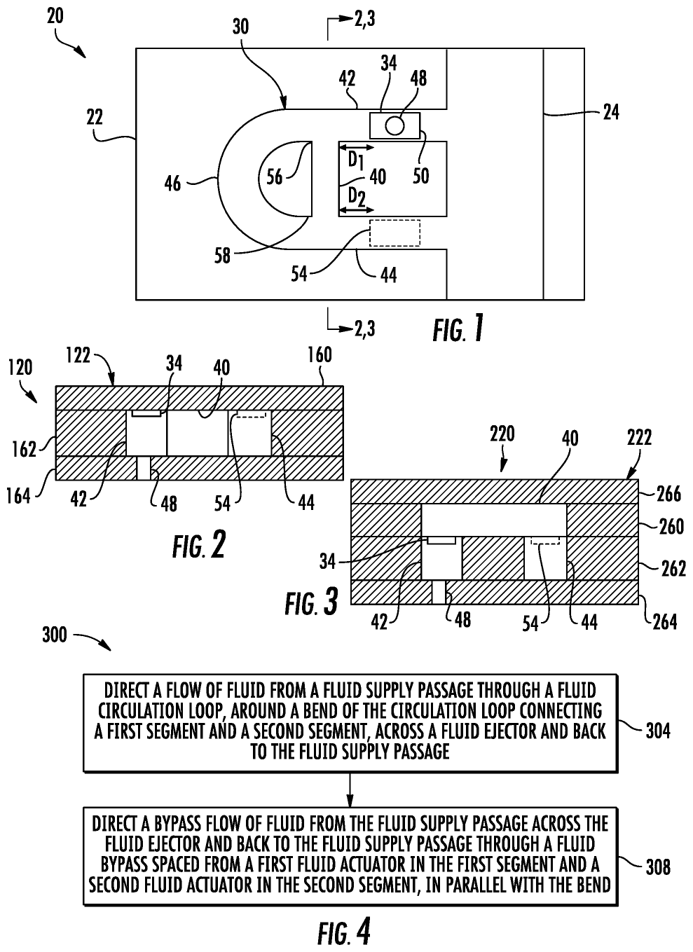

As shown by FIGS. 2 and 3, fluid bypass 40 may be coplanar with segments 42, 44 or may extend within a different plane, above or below that of segments 42 and 44. FIG. 2 is a sectional view of unit 120, taken along line 2,3-2,3 of FIG. 1 in which fluid bypass 40 is coplanar with segments 42 and 44. In implementations where fluid bypass 40 is coplanar with segments 42 and 44, unit 20 may have a reduced height.

Unit 120 comprises body 122. Body 122 comprises three layers 160, 162 and 164. Layer 160 supports fluid actuators 34 and 54 as well as the electrically conductive traces and circuitry associated with such fluid actuators 34 and 54. Layer 160 may be formed from material such as a silicon-based wafer or other such similar materials used for microfabricated devices (e.g., glass, gallium arsenide, plastics, etc.).

Layer 162 comprises a barrier layer that forms the ejection chamber adjacent to orifice 48 and that forms fluid bypass 40. Layer 164 comprises a nozzle or orifice layer 64 that forms orifice 48. In one implementation, barrier layer 162 and orifice layer 164 may be formed from a same material such as SUB. In other implementations, barrier layer 162 and orifice layer 164 may be integrally formed as a single unitary layer. In other implementations, barrier layer 162 and/or orifice layer 164 may be formed from other materials. In other implementations, body 122 may have other numbers of layers.

FIG. 3 is a sectional view unit 220, taken along line 2,3-2,3 of FIG. 1 in which fluid bypass 40 is coplanar with segments 42 and 44. In implementations where fluid bypass 40 is above or below segments 42, 44, a likelihood of cross talk between segments 42, 44 may be reduced. Unit 220 comprises body 222. In the example illustrated, body 222 comprises four layers, layer 260, layer 262, layer 264 and layer 266. Layers 260, 262 and 264 are each substantially similar to layers 160, 162 and 164, respectively, as described above except that fluid bypass 40 is formed in layer 260 rather than layer 262. Layer 260 extends on opposite transverse sides of fluid bypass 40. While supporting fluid actuators 42 and 44 along opposite to segments 42 and 44, respectively, layer 260 defines a channel or aperture that forms fluid bypass 40. The aperture formed within layer 260 and forming bypass 40 is covered or capped by layer 266. In some implementations, layers 260 and 266 may be integrally formed as a single unitary body or single layer, wherein the aperture forming fluid bypass 40 is etched, molded or otherwise formed in the single layer.

FIG. 4 is a flow diagram of an example fluid circulation method 300. Method 300 may facilitate enhanced fluid ejection reliability and by directing a bypass flow of fluid from the circulation passage through a fluid bypass and across the fluid ejector. Although method 300 is described as being carried out respect to unit 20, method 300 may likewise be carried out with any of the following disclosed fluid ejection unit or similar fluid ejection unit that have a fluid bypass spaced from fluid actuators in segments of the fluid circulation passage.

As indicated by block 304, a flow of fluid is directed from a fluid supply passage, such as fluid supply passage 24, through a fluid circulation loop, such as loop 30. The flow of fluid is directed around a bend of the circulation loop that connects the first segment and a second segment, and across a fluid ejector, back to the fluid supply passage. As indicated by block 308, a bypass flow of fluid is directed from the fluid supply passage across the fluid ejector and back to the fluid supply passage through a fluid bypass that is spaced from a first fluid actuator in the first segment and a second fluid actuator in the second segment. The fluid bypass is in parallel (in contrast to being in series) with the bend.

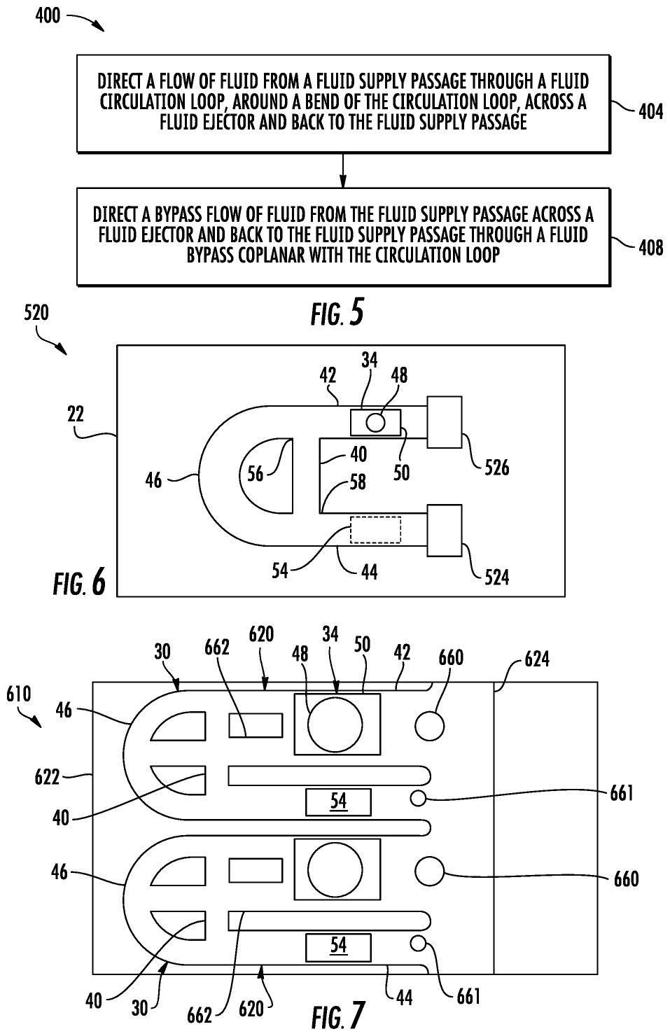

FIG. 5 is a flow diagram of an example fluid circulation method 400. Method 4 may facilitate enhanced fluid ejection reliability and by directing a bypass flow of fluid from the circulation passage through a fluid bypass and across the fluid ejector. Although method 4 is described as being carried out respect to unit 120, method 400 may likewise be carried out the following disclosed fluid ejection unit that a fluid bypasses that are coplanar with the circulation loop or similar fluid ejection unit.

As indicated by block 404, a flow of fluid is directed from a fluid supply passage, such as fluid supply passage 24, through a fluid circulation loop, such as loop 30. The flow of fluid is directed around a bend of the circulation loop that connects the first segment and a second segment, and across a fluid ejector, back to the fluid supply passage. As indicated by block 408, a bypass flow of fluid is directed from the fluid supply passage across the fluid ejector and back to the fluid supply passage through a fluid bypass that is coplanar with the circulation loop.

FIG. 6 is a schematic diagram illustrating portions of an example fluid ejection unit 520. Unit 520 directs a bypass flow of fluid from a circulation passage through a fluid bypass and across a fluid ejector. The fluid bypass facilitates the removal of bubble and particle constrictions from the circulation passage. The fluid bypass may further facilitate the flow of fluid around or passed any such constrictions. As a result, fluid ejection reliability is enhanced.

Unit 520 is similar to unit 20 described above except that unit 520 comprises a fluid supply passage 524 and a fluid discharge passage 526 in place of fluid supply passage 24. Those remaining components of unit 520 that correspond to components of unit 20 are numbered similarly. In one implementation, fluid bypass 40 is coplanar with segments 42 and 44 as an unit 120. In another implementation, fluid bypass 40 extends in a distinct plane from that of segments 42 and 44 as in unit 220.

Fluid supply passage 524 may comprise a fluid fill passage supplying fluid to segment 44. In one implementation, fluid supply passage 524 extends orthogonal to a plane containing bypass 40. In another implementation, fluid supply passage 524 may extend in a plane that is coplanar with or parallel to the plane containing bypass 40, such as where fluid supply passage 524 extends in a sideways direction with respect to segment 44. In one such implementation, fluid supplied to fluid supply specified for may be under pressure such that fluid actuator 54 may be omitted.

Fluid discharge passage 526 is connected to segment 42 with fluid ejector 34 located between fluid discharge passage 526 and fluid bypass 40 as well as bend 46. Fluid discharge passage 526 carries away fluid that has flowed across or passed fluid ejector 34. In one implementation, fluid discharge passage 526 is remotely fluidly connected to fluid supply passage 524 such that fluid may return to fluid circulation loop 30 via a fluid supply passage 524.

FIG. 7 is a schematic diagram illustrating portions of an example fluid ejection unit 620. Unit 620 directs a bypass flow of fluid from a circulation passage through a fluid bypass and across a fluid ejector. The fluid bypass facilitates the removal of bubble and particle constrictions from the circulation passage. The fluid bypass may further facilitate the flow of fluid around or passed any such constrictions. As a result, fluid ejection reliability is enhanced.

As shown by FIG. 7, fluid ejection unit 610 comprises two side-by-side fluid ejection units 620 positioned along a single fluid supply passage 624 and formed in body 622. Each of fluid ejection units 620 is similar to fluid ejection unit 20 except that each of fluid ejection units 620 additionally comprises filter posts 660, 661 and fluid bypass 662.

Filter posts 660 comprise posts positioned in front of segments 42, between fluid ejector 34 and fluid supply passage 624. Filter posts 661 comprise posts positioned in front of segments 44. In other implementations, each of units 620 may comprise a row, array or other arrangement of multiple filtering posts 660 and/or 661. In still other implementations, each of units 620 may comprise other filtering structures such as a mesh or the like or may omit filtering structures. In some implementations, unit 620 may omit one or both of posts 660, 661.

Fluid bypasses 662 comprise fluid passages that extend from segment 42 to bend 46. In the example illustrated, each of bypass 62 extend to an apex of bend 46. In the example illustrated, each of fluid bypasses 662 is coplanar with fluid bypass 40 so as to intersect fluid bypass 40. In other implementations, fluid bypasses 662 may be distinct from fluid bypasses 40, extending above or below fluid bypasses 40. Fluid bypasses 662 provide additional routes or pass for fluid to flow or bypass any constriction, a particle or air bubble) that might otherwise be occluding fluid circulation loop 30.

FIG. 8 is a schematic diagram illustrating portions of fluid ejection unit 710. Fluid ejection unit 710 is similar to fluid ejection unit 610 except that fluid ejection unit 710 comprises a series of fluid ejection units 720 (one of which is shown) extending along a single fluid supply passage 624. Fluid ejection unit 720 is similar to fluid ejection unit 620 except that fluid ejection unit 720 additionally comprises fluid bypass 740. The remaining components of fluid ejection unit 720 that correspond to fluid ejection unit 620 are numbered similarly.

Fluid bypass 740 is similar to fluid bypass 40. Fluid bypass 740 interconnects segments 42 and 44, bypassing bend 46. Fluid bypass 740 extends between segments 42 and 44 in parallel (as compared to being in series) with bend 46, between fluid bypass 40 and bend 46. In one implementation, fluid bypass 740 has a width of at least 5 μm and a height of at least 11 μm or less or equal to 50 μm to facilitate sufficient fluid flow through the bypass while not detrimentally producing flow through bend 46. In one implementation, bypass 740 has a length that is sufficiently short such that fluid may flow through bypass 740 with a given pressure differentials or the capabilities of the fluid actuator 54 serving as an inertial pump (when provided) and sufficiently long so as to reduce or eliminate cross talk between fluid being displaced by actuators 34 and 54. In one implementation, fluid bypass 740 is formed in a layer of SU eight and has a length of at least 5 μm and no greater than 21 μm (based upon a fluid actuator-to-fluid actuator pitch). In other implementations, such as where fluid bypass 740 is formed from other materials or other processes, or where the fluid ejection device is low-density, fluid bypass 740 may have a greater length.

Fluid bypass 740 is spaced from fluid actuator 50, having an inlet/outlet opening 56 spaced between actuator 50 and bend 46. In implementations where unit 20 comprises fluid actuator 54, fluid bypass 740 is also spaced from fluid actuator 54, having an inlet/outlet opening 58 spaced between actuator 54 and bend 46. In one implementation, opening 56 is spaced from actuator 50 by a distance D1 of at least 5 μm. In one implementation, opening 58 is spaced from actuator 54 by a distance D2 of at least 5 μm. The spacing of fluid bypass 740 from actuator 50 reduces the likelihood of fluid directly flowing through the fluid bypass absent a constriction, shortcutting a bend of the circulation passage. The spacing of bypass 740 from fluid actuator 54 reduces a likelihood of fluid being displaced by fluid actuator 54 interfering with the ejection of fluid by the fluid ejector.

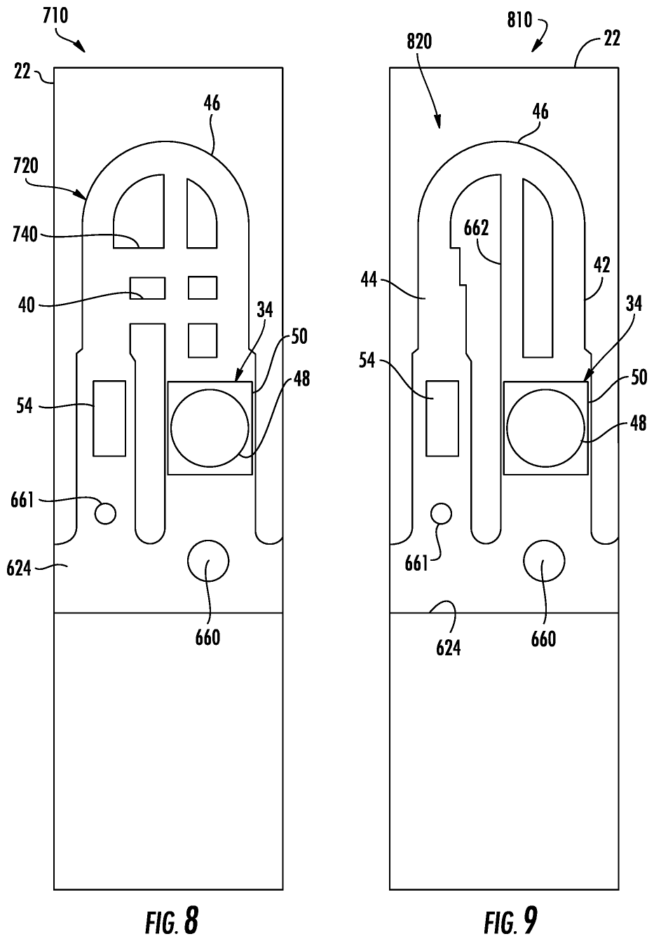

FIG. 9 is a schematic diagram illustrating portions of fluid ejection unit 810. Fluid ejection unit 810 is similar to fluid ejection unit 610 except that fluid ejection unit 710 comprises a series of fluid ejection units 820 (one of which is shown) extending along a single fluid supply passage 624. Fluid ejection unit 820 is similar to fluid ejection unit 620 except that fluid ejection unit 820 omits fluid bypass 40, relying upon fluid bypass 662. The remaining components of fluid ejection unit 820 that correspond to fluid ejection unit 620 are numbered similarly.

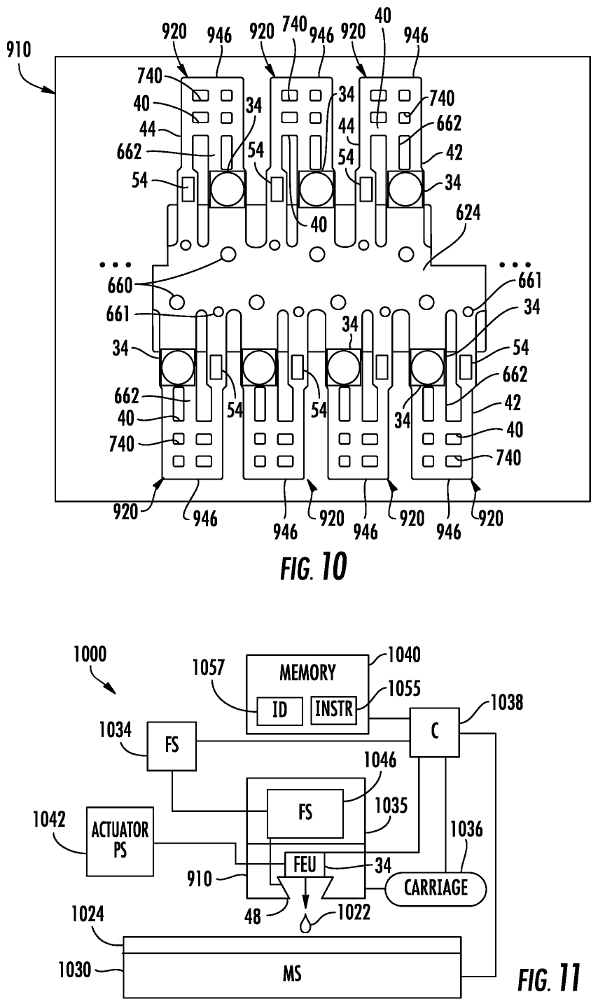

FIG. 10 is a schematic diagram illustrating portions of fluid ejection unit 910. Fluid ejection unit 910 is similar to fluid ejection unit 710 except that fluid ejection unit 910 comprises a series of fluid ejection units 920 (five of which are shown) extending and staggered along opposite sides of a single fluid supply passage 624. Each fluid ejection unit 920 is similar to fluid ejection unit 720 except that circulation loop 30 of fluid ejection unit 920 comprises bend 946 in place of bend 46. Bend 946 is similar bend 46 except that bend 946 is polygonal, rather than curved. Bend 946 comprises corners along which fluid flows from segment 44 to segment 42. The remaining components of fluid ejection unit 920 that correspond to fluid ejection unit 720 are numbered similarly.

FIG. 11 schematically illustrates an example fluid ejection system 1000 which incorporates fluid ejection unit 910. In other implementations, fluid ejection system 1000 may incorporate any of the other disclosed fluid ejection unit 20, 120, 220, 520, 610, 710 and 810. Fluid ejection system 120 is configured to selectively deliver drops 1022 of fluid or liquid onto a media 1024. In one implementation come media 1024 may comprise a sheet or web of cellulose material or other material. In yet other implementations, media 1024 may comprise a powder or other medium which may be selectively solidified to form a three-dimensional object.

Fluid ejection system 1020 utilizes drop-on-demand inkjet technology. Fluid ejection system 1020 comprises media supply 1030, fluid ejection unit 910, fluid supply 1034, carriage 1036, controller 1038, memory 1040 and actuator power supply system 1042. Media transport 1030 comprises a mechanism configured to transport or supply media 124 relative to print unit 132. In one example, media supply 1030 may comprise a series of rollers and a platen configured to support media 1024 as the liquid is deposited upon the print media 1024. In another example, media supply 1030 may comprise a drum upon which media 1024 is supported as the liquid is deposited upon medium 1024.

Fluid supply 1046 comprises an on-board volume, container or reservoir containing fluid in close proximity with fluid ejection unit 910. Fluid supply 1034 comprises a remote or off axis volume, container or reservoir of fluid which is supplied to fluid supply 1046 through one or more fluid conduits. In some examples, fluid supply 1034 may be omitted, wherein entire supply of liquid or fluid for print head 1044 is provided by fluid reservoir 1046. For example, in some examples, fluid ejection unit 910 may be provided as part of a print cartridge or print bar 1035 which is replaceable or refillable when fluid from supply 1046 has been exhausted.

Carriage 1036 comprise a mechanism configured to linearly translate or scan fluid ejection unit 910 and fluid supply 1046 relative to medium 1024 and media transport 1030. In some examples, fluid ejection unit 910 spans media transport 1030 and media 1024, such as with a page wide array printer, carriage 1036 may be omitted.

Controller 1038 comprises one or more processing units configured to generate control signals directing the operation of media transport 1030, fluid supply 1034, carriage 1036 and actuators 34, 54 of fluid ejection unit 910. For purposes of this application, the term “processing unit” shall mean a presently developed or future developed processing unit that executes sequences of instructions contained in a non-transitory computer-readable medium or memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other examples, hard wired circuitry may be used in place of or in combination with software instructions to implement the functions described. For example, controller 1038 may be embodied as part of one or more application-specific integrated circuits (ASICs). Unless otherwise specifically noted, the controller is not limited to any specific combination of hardware circuitry and software, nor to any particular source for the instructions executed by the processing unit.

In the example illustrated, controller 1038 carries out or follows instructions 1055 contained in memory 1040. In operation, controller 1038 generates control signals to fluid supply 1034 to ensure that fluid supply 1046 has sufficient fluid for printing. In those examples in which fluid supply 1034 is omitted, such control steps are also omitted. To effectuate printing based upon image or three-dimensional object data 1057 at least temporarily stored in memory 1040, controller 1038 generates control signals directing media transport 1030 to position media 1024 relative to print unit 1032. Controller 1038 also generates control signals causing carriage 1036 to fluid ejection unit 910 back and forth across print media 1024. In those examples in which fluid ejection unit 910 sufficiently spans media 1024 (such as with a page wide array), control of carriage 1036 by controller 1038 may be omitted.

Although the present disclosure has been described with reference to example implementations, workers skilled in the art will recognize that changes may be made in form and detail without departing from the spirit and scope of the claimed subject matter. For example, although different example implementations may have been described as including features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A fluid ejection unit comprising:
a fluid supply passage;
a fluid circulation loop having a first segment extending from the fluid supply passage, a second segment extending from the fluid supply passage and a bend connecting the first segment and the second segment;
a fluid ejector along the second segment, the fluid ejector comprising a fluid ejection orifice and a fluid actuator; and
a fluid bypass spaced from the first fluid actuator in parallel with the bend to connect the first segment and the second segment.

2. The fluid ejection unit of claim 1 further comprising a second fluid bypass extending from the second segment to the bend.

3. The fluid ejection unit of claim 2, wherein the second fluid bypass intersects the fluid bypass.

4. The fluid ejection unit of claim 3 further comprising a third fluid bypass extending from the first segment to the second segment in parallel with the bend between the fluid bypass and the bend, wherein the second fluid bypass intersects the third fluid bypass.

5. The fluid ejection unit of claim 2 further comprising a third fluid bypass extending from the first segment to the second segment in parallel with the bend between the fluid bypass and the bend.

6. The fluid ejection unit of claim 1, wherein the bend is rounded.

7. The fluid ejection unit of claim 1 further comprising a second fluid actuator along the first segment, wherein the fluid bypass is spaced form the second fluid actuator.

8. The fluid ejection unit of claim 1, wherein the fluid actuator comprises a thermal resistor.

9. The fluid ejection unit of claim 1, wherein the fluid bypass is coplanar with the first segment and the second segment.

10. A method comprising:
directing a flow of fluid from a fluid supply passage through a fluid circulation loop, around a bend of the circulation loop, across a fluid ejector and back to the fluid supply passage; and
directing a bypass flow of fluid from the fluid supply passage across a fluid ejector and back to the fluid supply passage through a fluid bypass coplanar with the circulation loop.

11. The method of claim 10 further comprising directing a second bypass flow of fluid from the fluid supply passage through a second fluid bypass coplanar with the circulation loop and in parallel with the bend.

12. The method of claim 10 further comprising directing a third bypass flow of fluid through a third fluid bypass that intersects the fluid bypass.

13. The method of claim 10 further comprising ejecting fluid through an orifice of the fluid ejector by heating a thermal resistor.

14. A fluid ejection unit comprising:
a fluid circulation passage having an inlet and an outlet;
a fluid actuator along the fluid circulation passage;
a fluid ejector along the circulation passage;
a fluid bypass coplanar with the fluid circulation passage and extending from a first portion of the fluid circulation passage to a second portion of the fluid circulation passage.

15. The fluid ejection unit of claim 14, wherein the inlet and the outlet are connected to a fluid supply passage.
